(19) United States
(12) Patent Application Publication
(10) Pub. No.: US 2002/0016800 A1
(43) Pub. Date: Feb. 7, 2002

(54) Method and apparatus for generating metadata for a document

(76) Inventors: Victor Spivak, San Mateo, CA (US); Alex Rankov, Danville, CA (US); Howard I-Hui Shao, Orinda, CA (US); Razmik Abnous, Danville, CA (US); Matthew Raymond Shanahan, Moraga, CA (US)

Correspondence Address: COOLEY GODWARD, LLP, 3000 EL CAMINO REAL, 5 PALO ALTO SQUARE, PALO ALTO, CA, 94306, US

(21) Appl. No.: 09/815,591

(22) Filed: Mar. 23, 2001

Related U.S. Application Data
(60) Provisional application No. 60/192,236, filed on Mar. 27, 2000.

(51) Int. Cl. G06F 15/00

(52) U.S. Cl. 707/523

(57) ABSTRACT

A method and system of generating metadata for a document so that the document may be identified by a subsequent search. A conceptual model is generated for the document, wherein the conceptual model indicates one or more concepts that are recognized in the document. A concept is defined by a plurality of features, each feature being associated with a feature weight. By referencing the conceptual model, one or more auto-attributes may be assigned to the document. Also, by referencing the conceptual model, the document may be categorized to one or more categories of a categorization taxonomy by assigning one or more auto-categories. The generated metadata, including the conceptual model, the one or more auto-attributes, and the one or more auto-categories, may be stored in a memory so that the subsequent search may identify the document by examining the generated metadata.

### CROSS REFERENCE TO RELATED APPLICATION

This application claims the benefit of U.S. Provisional Application Ser. No. 60/192,236, filed Mar. 27, 2000.

### BRIEF DESCRIPTION OF THE INVENTION

This invention relates generally to a method and system for identifying documents. More particularly, this invention relates to a method and system for generating metadata for a document so that the document may be identified by a subsequent search.

### BACKGROUND OF THE INVENTION

Various systems are designed to identify and retrieve documents within a computer network. Such systems include document search/retrieval systems associated with website usage. Such systems typically attempt to identify and retrieve documents that are the most relevant to a particular search. In order to meet this goal, documents may be associated with metadata. Metadata is information about information. In the present context, metadata is information about information in a document. Examples of metadata include document type, document title, author(s), and keyword(s). In a conventional search, a document's metadata may be matched to a search query. If the match is successful, the document is identified for the user who may choose to retrieve the document.

In the prior art, metadata are typically assigned to a document by an author or other human viewer. For instance, website managers typically manually assign metadata such as document type, document title, author(s), keywords, Hypertext Markup Language (“HTML”) dependencies, and expiration date. This manual assignment can be tedious and time-consuming. Moreover, this manual assignment is often prone to errors, and metadata assignments are often inconsistent, particularly when performed by more than one human viewer. Thus, for a website having tens of thousands of documents, it is difficult, if not impossible, to ensure that all documents are properly and consistently associated with metadata. As a result, documents that are relevant to a search query may not be identified, while other documents that are not relevant may be identified and retrieved.

The foregoing is particularly a problem when assigning metadata to a document that requires a human viewer to analyze the document and distill an idea or subject category. At the same time, metadata that represent an idea or subject category of a document may be the most useful for ensuring proper and efficient identification and retrieval of documents.

Consequently, there is a need for improved methods for generating document metadata to increase the likelihood that any given search will identify the relevant documents for subsequent review and/or retrieval.

### SUMMARY OF THE INVENTION

An embodiment of the invention is a computer-implemented method of processing a document. The method comprises converting a document into a common format document, recognizing a concept in said common format document, wherein said concept represents a basic idea expressed in said common format document, and incorporating said concept in a conceptual model.

Another embodiment of the invention is a computer-readable medium to direct a computer to function in a specified manner. The computer-readable medium comprises instructions to recognize a basic idea expressed in a document, instructions to assign a concept identification to said basic idea, and instructions to generate a conceptual model based upon said concept identification.

Another embodiment of the invention is a computer comprising a processor and a memory connected to said processor. The memory includes a document modeling module, said document modeling module having a first module configured to direct said processor to recognize a concept in a document, wherein said concept represents a basic idea expressed in said document, and a second module configured to direct said processor to generate a conceptual model based upon said concept.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a computer network that may be operated in accordance with an embodiment of the present invention.

FIG. 2 illustrates the processing steps that may be executed in accordance with an embodiment of the invention.

FIG. 3 provides a detailed description of the processing steps performed by a document integration module, according to an embodiment of the invention.

FIG. 4 illustrates a document modeling module, according to an embodiment of the invention.

FIG. 5 provides a detailed description of the processing steps performed by a document modeling module in recognizing one or more concepts in a document and in generating a conceptual model based upon the one or more concepts, according to an embodiment of the invention.

FIG. 6 illustrates a conceptual model for a document in an embodiment of the invention.

FIG. 7 illustrates a document modeling module in another embodiment of the invention.

FIG. 8 illustrates an example of a conceptual taxonomy, according to an embodiment of the invention.

FIG. 9 illustrates an example of a categorization taxonomy, according to an embodiment of the invention.

FIGS. 10A-E illustrate a sequence of processing steps that may be performed on a document in accordance with an embodiment of the invention.

### DETAILED DESCRIPTION OF THE INVENTION

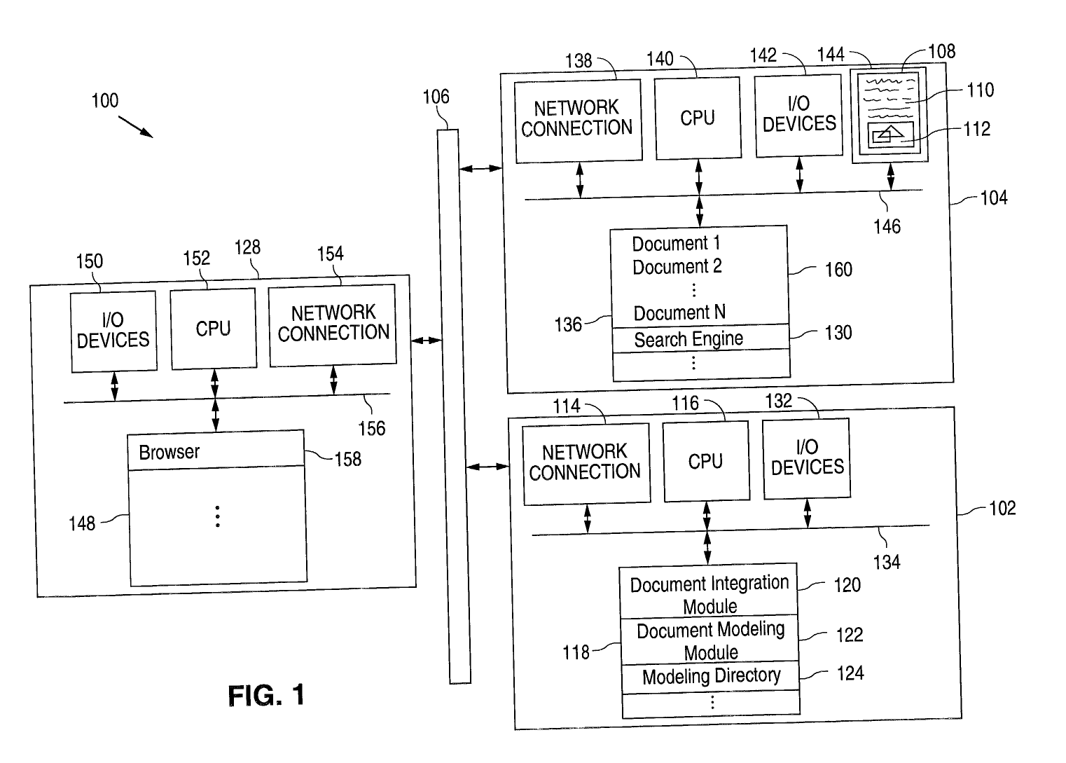

FIG. 1 illustrates a computer network 100 that may be operated in accordance with the present invention. The network 100 includes at least one server computer 102 connected to at least one document source 104. The server computer 102 and the document source 104 are connected by a transmission channel 106, which may be any wire or wireless transmission channel. The network 100 may also include at least one computer 128 connected to the document source 104 by the transmission channel 106. The computer 128 and the server computer 102 may also be connected by the transmission channel 106.

The document source 104 is an electronic device that retains a document to be processed by embodiments of the present invention. Examples of a document source include a server computer, such as a web server, a database server, or a file server, a client computer, and a PDA. While FIG. 1 shows a single document source 104 connected to the server computer 102, it should be recognized that multiple document sources may be connected to the server computer 102.

As shown in FIG. 1, the document source 104 is a server computer that includes conventional server computer components, such as a CPU 140 connected to a memory 136 (primary and/or secondary), a network connection device 138, a set of input/output devices 142 (e.g., keyboard, mouse, printer, etc), and a monitor 144 through a bus 146. The memory 136 stores one or more documents in a document storage 160. In particular, the memory 136 stores a document 108, which is displayed on the monitor 144.

The document 108 in the document source 104 includes a text portion 110. The text portion 110 typically includes a collection of alphanumeric characters, e.g., “When in the course of human events . . . ”. The text portion 110 may also include symbols, such as a dollar sign, a mathematical symbol, or a logic symbol. The document 108 may also include a non-text portion 112, such as an audio portion, a visual portion, such as a JPEG image, and/or an audio-visual portion, such as a motion picture sequence. The document 108 may be in a conventional format, such as, for example, Hypertext Markup Language (“HTML”) format, Extensible Markup Language (“XML”) format, Microsoft Office (Word, Excel, PowerPoint), PDF file format, WordPerfect, or simply plain text.

As shown in FIG. 1, the memory 136 also includes a search engine 130, which is any application configured to identify one or more of the documents stored in the document storage 160, such as document 108, in accordance with a search query. The search query may be generated in response to input from a user of the computer 128.

The computer 128 may be a server computer, including conventional server computer components, or a client computer, including conventional client computer components. As shown in FIG. 1, the computer 128 is a client computer that includes a CPU 152 connected to a memory 148 (primary and/or secondary), a network connection device 154, and a set of input/output devices 150 (e.g., keyboard, mouse, printer, monitor, etc) through a bus 156. The memory 148 includes a conventional browser 158, which may display for a user one or more documents identified by the search engine 130.

The server computer 102 may comprise standard server components, including a CPU 116 connected to a memory 118 (primary and/or secondary), a network connection device 114, and a set of input/output devices 132 (e.g., keyboard, mouse, printer, monitor, etc) through a bus 134. The memory 118 stores a set of computer programs that implement the processing associated with the invention. In particular, the memory 118 stores a document integration module 120 and a document modeling module 122.

The document integration module 120 receives a document in an initial format from the document source 104, converts the document in the initial format into a common format document, and submits the common format document to the document modeling module 122 for further processing. The document integration module 120 typically receives a copy of a document (e.g., an original document) stored in the document source 104. With reference to FIG. 1, the document integration module 120 receives a copy of the document 108, which copy includes the text portion 110 and the non-text portion 112, and converts the copy in its initial format to a common format document for processing by the document modeling module 122.

The document integration module 120 may separate the text portion 110 from the non-text portion 112 and may incorporate the text portion 110 in the converted copy of the document 108. In addition, the document integration module 120 may retrieve metadata of the document 108 in the form of one or more original attributes and incorporate the one or more original attributes in the common format document. An original attribute of a document is metadata that has already been generated (for example, by an author of the document or by an embodiment of the invention) and that is incorporated in the document (and/or in a copy of the document) and/or the document source 104 holding the document. Such original attributes may include information such as document title, document author, document creation date, document number, and number of pages. For example, a document's creation date may be “Jan. 1, 2001” and may be included in the document's header section. The document integration module 120 may retrieve one or more original attributes of document 108 from its copy and/or from the document source 104.

The document modeling module 122 generates metadata for the document 108, so that the document 108 may be identified by the search engine 130. The document modeling module 122 attempts to recognize one or more concepts in the common format document. A concept represents a basic idea that may be expressed in a document. Examples of concepts include “computer”, “network application”, and “competitor company”. A concept need not be literally found or found in an abbreviated or stemmed form in a document in order to be recognized by the document modeling module 122. The number of concepts that is recognized by the document modeling module 122 depends upon the content of a document, and it is possible for the document modeling module 122 to recognize no concepts in a particular document. The document modeling module 122 generates a conceptual model for the document 108 based upon the recognized concepts in the converted copy of document 108. A conceptual model identifies or indicates one or more concepts that are recognized in a document. For example, a conceptual model for a document could include “Company A” and “Company B”, where concept “Company A” and concept “Company B” are concepts that are recognized in the document.

The document modeling module 122 may additionally generate or assign one or more auto-attributes to the document 108. An auto-attribute represents a descriptive label for a document that is generated or assigned to the document based on the document's conceptual model and/or one or more original attributes. An auto-attribute includes an alphanumeric and/or symbolic string. An example of an auto-attribute includes “Useful Document”.

The document modeling module 122 may also categorize the document 108 into one or more document categories of a categorization taxonomy, such as by generating or assigning one or more auto-categories to the document 108. An auto-category represents a descriptive label for a category that is generated or assigned to a document based on the document's conceptual model and/or one or more original attributes and/or one or more auto-attributes. An auto-category includes an alphanumeric and/or symbolic string. For example, a document assigned to a category “U.S. Politics” may be assigned an auto-category “U.S. Politics”.

The document modeling module 122 may store a portion of the generated metadata (including the conceptual model, the one or more auto-attributes, and the one or more auto-categories) in a modeling directory 124. The modeling directory 124 may be any data repository, such as, for example, a relational database. The document modeling module 122 associates at least the stored portion of the generated metadata with the document 108 in the document source 104, such as by providing a link or identifier that identifies and/or provides location of the document 108 in the document source 104.

The search engine 130 may access the modeling directory 124, for example, via transmission channel 106. Upon examining a portion of the stored metadata for the document 108, the search engine 130 may identify the document 108 if the stored metadata matches a search query. Having identified the document 108, the search engine 130 may indicate the document 108 to a user of computer 128, and the user may retrieve the document 108 from the document source 104.

Alternatively, or in conjunction with the above, the server computer 102 may transmit at least a portion of the generated metadata to the document source 104. The document modeling module 122 associates at least the transmitted portion of the metadata with the document 108 in the document source 104, such as by providing a link or identifier that identifies the document 108 in the document source 104. The document source 104 may store the transmitted portion of the metadata in the memory 136. The search engine 130 may examine at least a portion of the metadata that is stored in the memory 136 and may identify the document 108 if the stored metadata matches a search query.

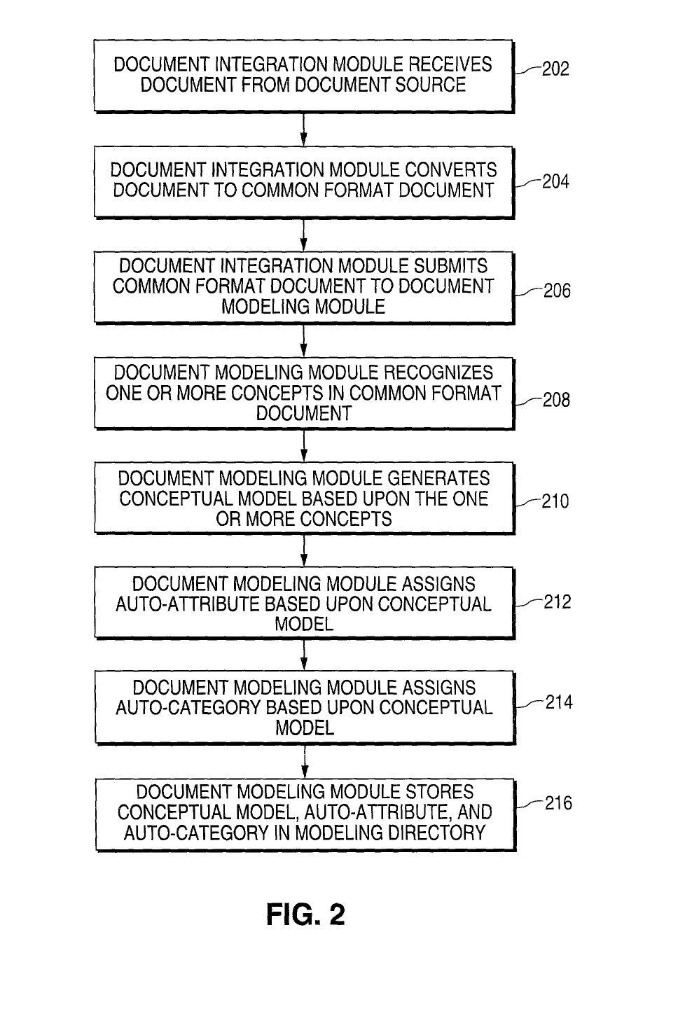

The invention is further explained in reference to FIG. 2, which illustrates the processing steps that may be executed in accordance with an embodiment of the invention. A document integration module 120 receives a document from a document source 104 (step 202). In this embodiment, the document is a copy of an original document retained in the document source 104. The document integration module 120 converts the document to a common format document (step 204) and submits the common format document to a document modeling module 122 (step 206). The document modeling module 122 recognizes one or more concepts in the common format document (step 208) and generates a conceptual model for the original document based upon the one or more concepts (step 210). The conceptual model indicates one or more concepts that the document modeling module 122 has recognized in the common format document. The document modeling module 122 assigns one or more auto-attributes to the original document based upon the conceptual model (step 212). Also, based upon the conceptual model, the document modeling module 122 categorizes the original document to one or more categories by assigning one or more auto-categories to the original document (step 214). The document modeling module 122 stores at least a portion of the generated metadata (i.e., the conceptual model, the one or more auto-attributes, and the one or more auto-categories) in a modeling directory 124 (step 216). This stored metadata may be provided with a link or identifier that identifies and/or provides the location of the original document in the document source 104.

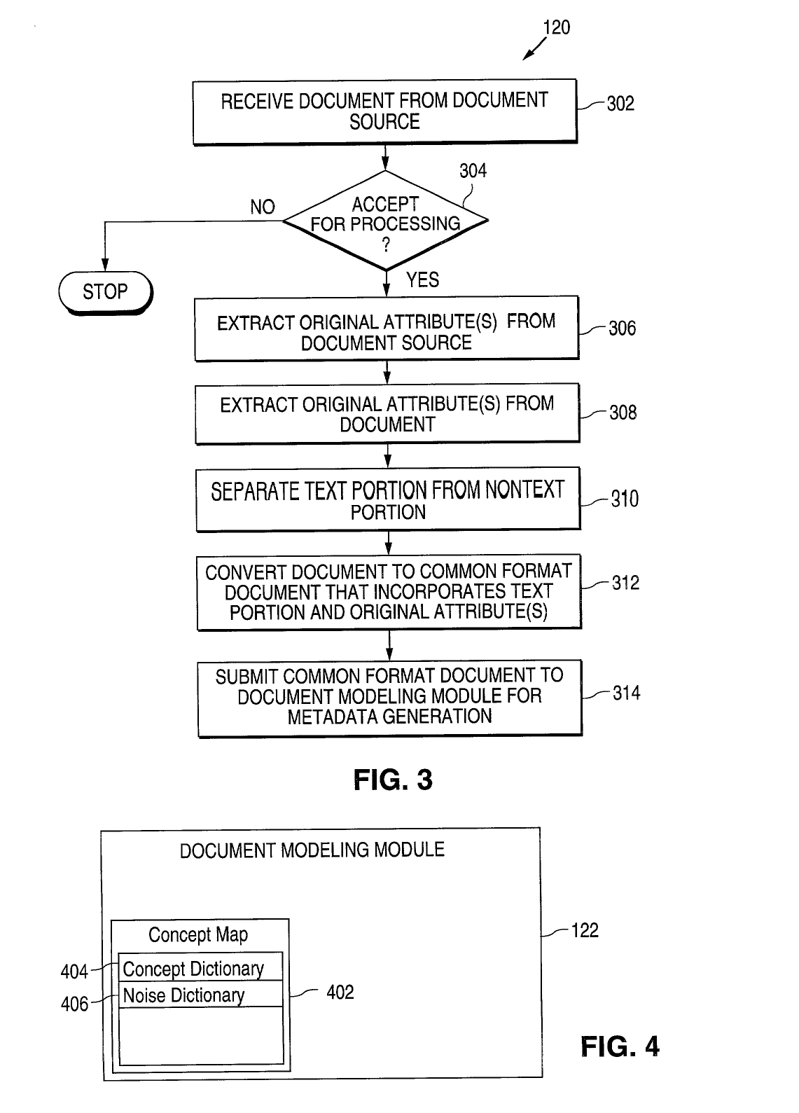

FIG. 3 provides a detailed description of the processing steps performed by a document integration module 120, according to an embodiment of the invention. The document integration module 120 receives a document from a document source 104 (step 302). In an embodiment of the invention, the document integration module 120 automatically retrieves the document from the document source 104. The document may be a newly created or newly modified document (or a copy thereof) or may be an old document (or a copy thereof) that has not yet undergone the processing performed by embodiments of the invention. In addition to a document being automatically retrieved by the document integration module 120, a user may submit a document from the document source 104 to the document integration module 120. In an embodiment of the invention, the document integration module 120 retrieves a document in response to instructions from a user. In either event, the document integration module 120 receives a document in step 302 and initiates the subsequent processing described below.

As shown in FIG. 3, the document integration module 120 evaluates the document to determine whether or not to accept the document for further processing (step 304). In an embodiment of the invention, the document is evaluated against one or more criteria to determine whether processing should continue. For example, a maximum page limit may be established as a criterion, so that a document with a number of pages exceeding the maximum page limit may not be accepted for further processing and/or the document may undergo a modified form of processing. An acceptable document format may be another criterion, so, for example, a document in other than a Word, Excel, PowerPoint, HTML, or WordPerfect format will not be further processed and/or may be converted into an acceptable document format. Another example of a criterion includes page depth for documents received from a web server.

Metadata in the form of one or more original attributes may be retrieved from the document source 104 (step 306). Examples of an original attribute that may be found in the document source 104 include a document's creation date, author, document title, and one or more keywords. Depending upon availability and upon the document source 104, anywhere from zero to several original attributes may be extracted from the document source 104.

Metadata in the form of one or more original attributes may also be extracted from the document itself (step 308). As an ordinary artisan will understand, various document formats may include one or more original attributes that may be extracted. For example, a document in a HTML format may include a document title bracketed by tags “<Title>”and “</Title>”. In this example, the document title may be extracted as an original attribute for the document. As another example, a Word document may include a time/date stamp in a footer section, and the time/date stamp may be extracted as an original attribute. Depending upon availability and upon the particular document format, anywhere from zero to several original attributes may be extracted from the document itself.

In processing step 310, a text portion 110 is separated from a non-text portion 112 of the document. The text portion 110 typically includes a collection of alphanumeric characters, e.g., “When in the course of human events . . . ”. The text portion 110 may also include abbreviations and/or symbols, e.g., “Mr.” or “?”. In step 310, the document integration module 120 separates out the text portion 110 from any portion of the document that might interfere with further processing of the document. Examples of the non-text portion 112 include banners on a web page and a still image pasted onto a Word document. In one embodiment of the invention, the text portion 110 is extracted from the document. In another embodiment of the invention, the non-text portion 112 is extracted while the text portion 110 remains in the document for further processing.

As shown in FIG. 3, the document integration module 120 converts the document in its original format as received from the document source 104 to a common format document for further processing by the document modeling module 122 (step 312). In an embodiment of the invention, the common format selected is an XML format. In converting the document to the XML format, one embodiment of a document integration module 120 incorporates the text portion 110 separated from step 310 and the original attributes extracted from steps 306 and 308 in the common format document. In particular, the text portion 110 and the original attributes are combined and marked by a set of tags. Unlike HTML, the XML format is not limited to a fixed set of tags but allows new tags to be defined. In the present invention, tags may be used to enable the document modeling module 122 to identify parts of an XML document. An original attribute extracted in either step 306 or step 308 may be bracketed by a pair of tags in the XML document. For example, a document title “Document About Computers” extracted from a database server may be found in the XML document bracketed by tags as follows: <Document Title>Document About Computers</Document Title>. A document modeling module 122 processing this XML document may identify a Document Title original attribute having a value “Document About Computers”. The text portion 110 separated from step 310 may also be bracketed by a pair of tags. In an embodiment of the invention, the document integration module 120 brackets each paragraph of the text portion 110 by a pair of tags. For example, a first paragraph in the XML document may be bracketed by a pair of tags <paragraph 1> and </paragraph 1>. Since the XML format allows new tags to be defined, there is flexibility in defining tags to be used in the invention. For instance, in one embodiment of the invention, a tag pair <Document Title> and </Document Title> may be defined and used to bracket a document title extracted from a document or a document source. In an alternate embodiment, one may define a tag pair <DT> and </DT> for the same purpose. As will be recognized by one of ordinary skill in the art, the choice of definition of the tags used in the invention may be guided by considerations of computation efficiency and speed.

It should be recognized that processing may be performed in step 312 even for a document received from a document source in an XML format. Since the XML format allows flexibility in defining tags, an XML document received from a document source may be marked by a different set of tags, and the document integration module 120 may remark the XML document by a set of tags used in the invention. It should be further recognized that document formats other than XML may be selected as the common format in the invention. For example, one may select other document formats that provide a degree of structure to a document so that the document modeling module 122 may identify different parts of the document, such as a document title or one or more paragraphs of a document.

As shown in step 314, the document integration module 120 submits the common format document for processing by the document modeling module 122. In an embodiment of the invention in which the document integration module 120 and the document modeling module 122 reside in a single server computer 102 (as, for example, illustrated in FIG. 1), the document in the common format need not be physically relocated in step 314. In an alternate embodiment of the invention, the document integration module 120 and the document modeling module 122 may reside in separate server computers, and the common format document would be transmitted over a transmission channel between the two server computers.

FIG. 4 illustrates a document modeling module 122, according to an embodiment of the invention. The document modeling module 122 recognizes one or more concepts in a document and generates a conceptual model for the document, wherein the conceptual model indicates one or more of the recognized concepts.

As shown in FIG. 4, the document modeling module 122 includes a concept map 402. The concept map 402 includes information that enables the document modeling module 122 to recognize concepts and to generate a conceptual model for a document. In particular, the concept map 402 includes a concept dictionary 404 and a noise dictionary 406.

The concept dictionary 404 defines a plurality of concepts that the document modeling module 122 may recognize in a document. A concept need not be literally found or found in an abbreviated or stemmed or other equivalent form in a document in order to be recognized. For example, a document may express a concept “Internet” even though the document does not include the word “Internet” (or an abbreviated or stemmed or other equivalent form of the word “Internet”).

In an embodiment of the invention, each concept may be defined by a corresponding set of features. A feature represents evidence of a given concept in a document. More particularly, a feature represents evidence that a basic idea represented by a given concept is expressed in a document. For example, a concept “IBM” may be defined by a feature set comprising the features “IBM”, “International Business Machines”, “Big Blue”, and “computer”. It should be recognized that a concept's literal expression (or an abbreviated or stemmed or other equivalent form thereof) may be a feature for the concept. In the previous example, the presence of “IBM” in a document provides evidence that the concept “IBM” is expressed in the document. The concept dictionary 404 may include a plurality of feature sets (or concept definitions) corresponding to a plurality of concepts. In an embodiment of the invention, the document modeling module 122 determines whether each feature of a concept's feature set is present in a document.

In an embodiment of the invention, each feature of a feature set defining a concept is associated with a feature weight, and the concept dictionary 404 may also include the feature weights associated with each feature set. A feature's feature weight indicates a confidence level that a concept is expressed if the feature is identified in a document. In an embodiment of the invention, a feature weight has a numerical value, such as, for example, a number between 0 to 1, with 0 being a lowest confidence level and 1 being a highest confidence level. In reference to the previous example, the presence of “IBM” in a document gives a very strong indication that the concept “IBM” is expressed in a document, and the feature weight for the feature “IBM” may be assigned to be 1. On the other hand, the presence of “Big Blue” in the document gives a lesser indication that the concept “IBM” is expressed in the document, and the feature weight for the feature “Big Blue” may be assigned to be 0.15.

In an embodiment of the invention, a feature set for a concept includes one or more features with feature weights having relatively low numerical values, such as, for example, less than 0.1 on a scale of 0 to 1. While a feature with a low feature weight value may provide a low confidence level that a concept is expressed, such feature may nonetheless be included to prevent ambiguity and hence facilitate concept recognition. For instance, a feature “computer” may be included in a feature set for a concept “Apple Computer” but may not be included in a feature set for a concept “Apple” as a fruit. The presence of the feature “computer” may provide little indication that the concept “Apple Computer” is expressed, since “computer” is generic. In this example, the feature “computer” may be assigned a feature weight that is less than 0.1, such as, for example, 0.05. However, the presence of “computer” in a document may facilitate recognizing the concept “Apple Computer” as opposed to the concept “Apple” as a fruit.

In an embodiment of the invention, a feature need not be literally found or found in an abbreviated or stemmed or other equivalent form in a document in order to be identified. In particular, one embodiment of the invention includes one or more concepts as features for another concept. In other words, the fact that a document expresses a concept may provide evidence that the document expresses another concept. A feature that is a concept is a concept-feature, and the concept-feature may be associated with a feature weight as with features that are not concepts. A document modeling module 122 determines a feature, which is a concept, to be present in a document if the document modeling module 122 recognizes the concept in the document.

As shown in FIG. 4, the concept map 402 also includes the noise dictionary 406. The noise dictionary 406 indicates one or more words that should not be recognized as auto-concepts. According to an embodiment of the invention, an auto-concept may be a word (or group of words) that appears repeatedly in a document and that is not included (literally or in an abbreviated or stemmed or other equivalent form) as a feature in the concept dictionary 404. For example, a word “internet” may appear several times in a document, but “internet” may not be included as a feature in the concept dictionary 404. The document modeling module 122 may recognize the word “internet” as a concept that is an auto-concept unless it is included (literally or in an abbreviated or stemmed or other equivalent form) in the noise dictionary 406.

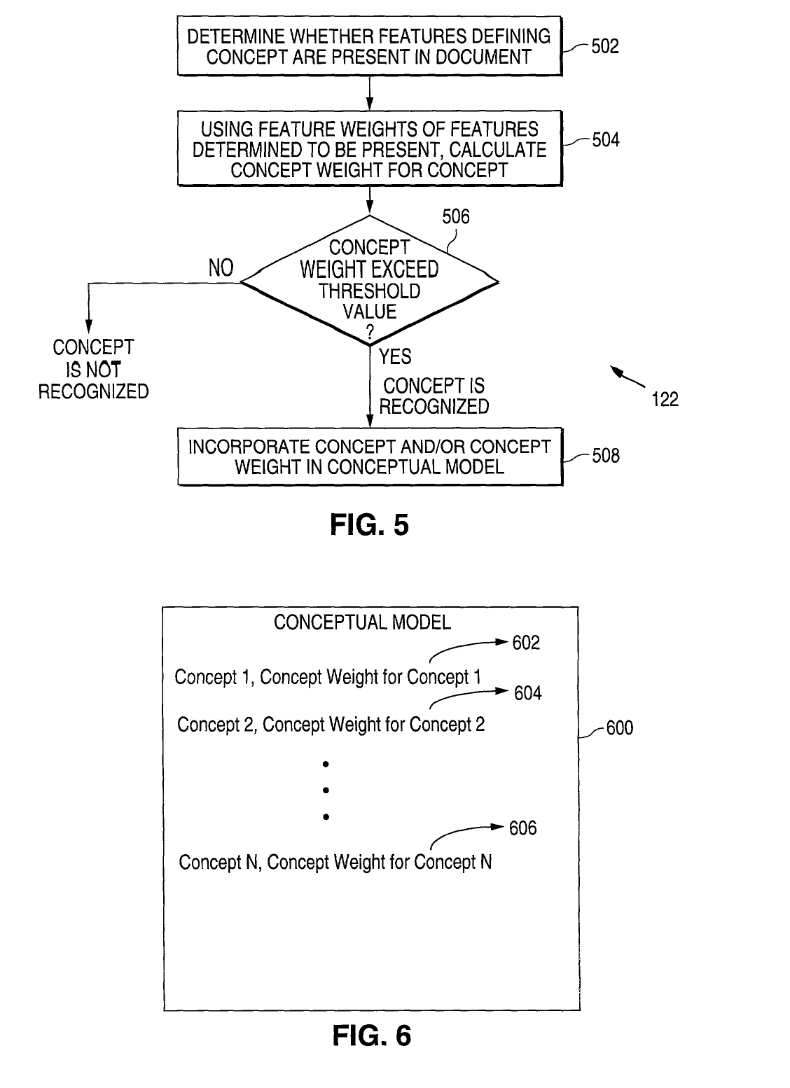

FIG. 5 provides a detailed description of the processing steps performed by a document modeling module 122 in recognizing one or more concepts in a document and in generating a conceptual model based upon the one or more concepts, according to an embodiment of the invention. The document modeling module 122 may perform the processing steps shown in FIG. 5 for one or more concepts defined in a concept map 402.

In an embodiment of the invention, a document processed by the document modeling module 122 is in an XML format. For example, the document is a XML document submitted by a document integration module 120. The XML document is marked by a set of tags that enables the document modeling module 122 to identify various parts of the XML document, such as an original attribute or a first paragraph. It should be recognized that other document formats that provide a degree of structure to a document may be used instead of the XML format. Furthermore, it should be recognized a document modeling module 122 in accordance with an embodiment of the invention may process a document in any conventional format, such as, for example, HTML, Microsoft Office (Word, Excel, PowerPoint), PDF file format, WordPerfect, or simply plain text.

As shown in FIG. 5, the document modeling module 122 determines whether features for a concept defined in a concept dictionary 404 are present in the document (step 502). As noted previously, in an embodiment of the invention, each concept is defined in the concept dictionary 404 by a corresponding set of features, and the document modeling module 122 references the concept dictionary 404 when performing the determining step 502. In particular, the document modeling module 122 may retrieve one or more feature sets (and/or associated feature weights) corresponding to one or more concepts defined in the concept dictionary 404.

In step 502, an embodiment of the document modeling module 122 determines whether each feature of a feature set is present in the document. One embodiment of the document modeling module 122 searches for a feature and/or a stemmed version or versions of the feature in a document. For example, the invention may search for the feature “explorer” and/or its stemmed version “explore” in the document. In an embodiment of the invention, a variation of a feature may be deemed equivalent to the feature, and the document modeling module 122 may identify the feature in a document if the variation is found in the document. In other words, the document modeling module 122 may recognize not just the feature but also one or more variations of the feature. For example, a feature “computer” and the feature with one or more letters capitalized (for example “Computer”) may be deemed to be equivalent. Also, a feature and a stemmed version or versions of the feature may be deemed to be equivalent, for example. As a further example, a feature and its one or more synonyms may be deemed to be equivalent. In an embodiment of the invention, the concept dictionary 404 includes a feature and one or more variations that are deemed to be equivalent to the feature. It should be recognized that one or more equivalent variations of a feature may be defined by a user. Alternatively, or in conjunction with the above, the concept dictionary 404 may include an algorithm that enables the document modeling module 122 to automatically generate one or more variations of a feature that are deemed equivalent to the feature. For example, an algorithm may be a stemming algorithm that generates a stemmed version or versions of a feature that are deemed equivalent to the feature.

According to an embodiment of the invention, the determining step 502 is separately performed for each paragraph of a document. For a document with two paragraphs, for example, the document modeling module 122 determines whether features for a concept are present in a first paragraph and separately determines whether features for the concept are present in a second paragraph.

In an embodiment of the invention where the determining step 502 is performed for each paragraph of a document, an additional aspect of the invention is explained by the following example. A document with two or more paragraphs may include “Joe Smith” in an earlier paragraph and in one or more later paragraphs may include a shortened form “Smith”. In this example, “Joe Smith”, but not “Smith”, is included as a feature in the concept dictionary 404. If the document modeling module 122 determines the feature “Joe Smith” to be present in the earlier paragraph, the document modeling module 122 may also determine the feature to be present in the one or more later paragraphs that only include the shortened form “Smith”. In an embodiment of the invention, the document modeling module 122 recognizes the shortened form of “Joe Smith” on the basis of the last word of the multi-word feature (i.e., “Smith”). In this embodiment, “Smith” is automatically recognized as an equivalent of the feature “Joe Smith”.

After determining whether features of the concept are present, the document modeling module 122 calculates a concept weight for the concept (step 504). A concept weight indicates a recognition confidence level of a given concept in a document. The document modeling module 122 calculates the concept weight using the feature weights associated with features that are determined to be present. In an embodiment of the invention, a mathematical relation relates the concept weight to the feature weights of features determined to be present. For example, a concept weight may be linearly related to these feature weights, such as involving a sum or a weighted-sum of these feature weights. For instance, a concept “Internet” may be defined by a feature set comprising the features “web”, “network”, and “computer”. The three features may have associated feature weights of 0.9, 0.5, and 0.05, respectively. After determining that the features “web” and “computer” are present in a document, the document modeling module 122 may calculate a concept weight for the concept “Internet” by adding the feature weights 0.9 and 0.05 to yield 0.95 as the concept weight.

In an embodiment where feature weights are assigned numerical values, such as a number between 0 and 1, a calculation for the concept weight may yield a number greater than a number related to a highest recognition confidence level, such as 1. In this instance, the numerical value for the concept weight may be set or adjusted to not exceed the number related to the highest recognition confidence level. For example, if a concept weight for a concept is calculated to be a number greater than 1, the concept weight is set to be 1. In another embodiment, concept weights associated with a plurality of recognized concepts are normalized so that the sum of the concept weights equals a predetermined number, such as 1. For example, a concept weight of 0.8 for a recognized concept “Company A” and a concept weight of 0.6 for a recognized concept “Company B” may be normalized by dividing each concept weight by 1.4. In this example, the sum of the normalized concept weights 0.8/1.4 and 0.6/1.4 equals 1.

In an embodiment of the invention where the determining step 502 is performed for each paragraph of a document, a concept confidence level for a concept may also be calculated for each paragraph of the document. The concept confidence level indicates a recognition confidence level of a given concept in a particular paragraph. The concept confidence level for a paragraph is calculated using the feature weights associated with features that are determined to be present in the paragraph. In an embodiment of the invention, a mathematical relation relates the concept confidence level to these feature weights. For example, a concept confidence level may be linearly related to these feature weights, such as involving a sum or a weighted-sum of these feature weights. A concept weight for a concept is then calculated using the calculated concept confidence levels for the one or more paragraphs. In an embodiment of the invention, a mathematical relation relates the concept weight to these concept confidence levels. For example, a concept weight may be linearly related to these concept confidence levels, such as involving a sum or a weighted-sum of these concept confidence levels. In an embodiment of the invention, the concept weight is calculated by adding the concept confidence levels for the various paragraphs of a document. For this embodiment, it should be recognized the concept weight not only indicates a recognition confidence level of a given concept in a document but also indicates a frequency at which the document expresses the concept. For instance, a concept “computer” that is recognized with a highest confidence level in only one paragraph will have a lower concept weight than a concept “network application” that is recognized with a highest confidence level in two paragraphs. As discussed previously, the concept weight may be set to not exceed a particular number or normalized so that the sum of concept weights of recognized concepts equals a predetermined number.

The document modeling module 122 compares the calculated concept weight of the concept from step 504 to a predetermined threshold value (step 506). The threshold value indicates a recognition confidence level above (or at and above) which a concept is deemed to be recognized. For example, in an embodiment where concept weights have numerical values ranging from 0 to 1 and a threshold value is set to 0.1, a concept with concept weight of less than 0.1 is determined to be unrecognized, while a concept with a concept weight greater than 0.1 is determined to be recognized.

In accordance with the comparing step 506, the document modeling module 122 may incorporate a recognized concept and/or its associated concept weight in a conceptual model (step 508). FIG. 6 illustrates a conceptual model 600 for a document according to an embodiment of the invention. As shown in FIG. 6, the conceptual model 600 includes a plurality of entries 602, 604, 606. Each entry indicates a recognized concept in the document. In FIG. 6, concept 1, concept 2, through concept N are concepts that a document modeling module 122 has recognized in the document. In this embodiment, the conceptual model 600 also indicates the concept weights for the recognized concepts.

According to an embodiment of the invention, a conceptual model 600 may also indicate one or more recognized concepts that are auto-concepts. In particular, the document modeling module 122 may recognize one or more concepts that are auto-concepts. An auto-concept may be a word (or group of words) that appears repeatedly in a document and that is not recognized as a feature or a variation of a feature in a concept dictionary 404. The document modeling module 122 may recognize this word (or group of words) as an auto-concept unless the word is included (literally or in an abbreviated or stemmed or other equivalent form) in the noise dictionary 406 shown in FIG. 4. The concept weight of an auto-generated concept may be set to a predetermined value, such as a value corresponding to a highest recognition confidence level.

It should be recognized that the document modeling module 122 may generate one or more different versions of the conceptual model 600. In a first version, the conceptual model 600 may indicate all recognized concepts (and associated concept weights), except possibly for auto-concepts, in a document. Such a conceptual model 600 is useful for a conceptual search, for example. A search engine 130 configured to perform a conceptual search may identify one or more documents that express one or more concepts specified in a search query. In performing the conceptual search, the search engine 130 may examine a conceptual model 600 of a document to locate the one or more concepts specified in the search query.

In a second version, the conceptual model 600 may indicate N most significant recognized concepts in the document, where N is a predetermined number. Specifically, the document modeling module 122 may sort the recognized concepts by concept weight and may indicate the N recognized concepts with the highest values of concept weight in the conceptual model 600. Such a conceptual model 600 is useful for conceptual searches involving “queries by example” (QBE), for example. A search engine 130 configured to perform a conceptual QBE search may identify one or more documents that express similar concepts with a similar confidence level (and/or emphasis) compared to a document of interest. In performing the conceptual QBE search, the search engine 130 may examine a conceptual model 600 of a document and compare this conceptual model 600 to a conceptual model 600 of the document of interest. The greater the match between the two conceptual models, the more two documents may express similar ideas with similar confidence level (and/or emphasis). It should be recognized that this version of a conceptual model 600 is akin to a “key concepts” list.

The document modeling module 122 may generate other versions of the conceptual model 600. For example, a conceptual model 600 may indicate one or more recognized concepts but not the associated concept weights. Also, the document modeling module 122 may incorporate one or more recognized concepts in a conceptual model 600 by including one or more concept identifications associated with the one or more recognized concepts. A concept identification, which may be any alphanumeric and/or symbolic string, uniquely identifies a recognized concept. It should be recognized that a concept identification of a given concept need not include a literal expression of the concept. For example, a concept identification “1” may be used to uniquely identify a concept “web browser”, and “1” may be included in a conceptual model in place of “web browser”. In this example, a mapping between the concept identification “1” and the concept “web browser” may be included in the concept map 402. In an embodiment of the invention, a document modeling module 122 assigns a concept identification to a recognized concept and generates a conceptual model based upon the concept identification.

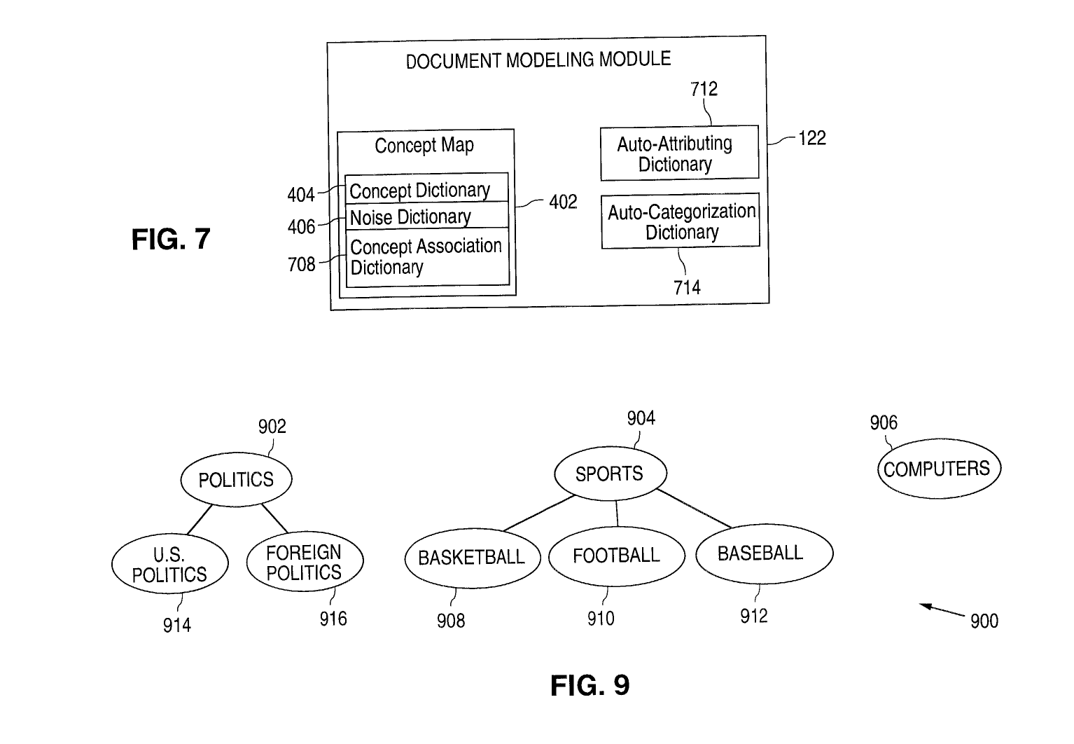

FIG. 7 illustrates a document modeling module 122, according to an alternate embodiment of the invention. As shown in FIG. 7, the document modeling module 122 includes a concept map 402, and the concept map 402 includes the concept dictionary 404 and the noise dictionary 406 as discussed previously in connection with FIG. 4. In this embodiment, the concept map 402 also includes a concept association dictionary 708.

The concept association dictionary 708 includes information that defines relationships (or concept associations) between two or more concepts included in the concept dictionary 404. Two concepts may be related by a concept association if the ideas represented by the two concepts are somehow linked.

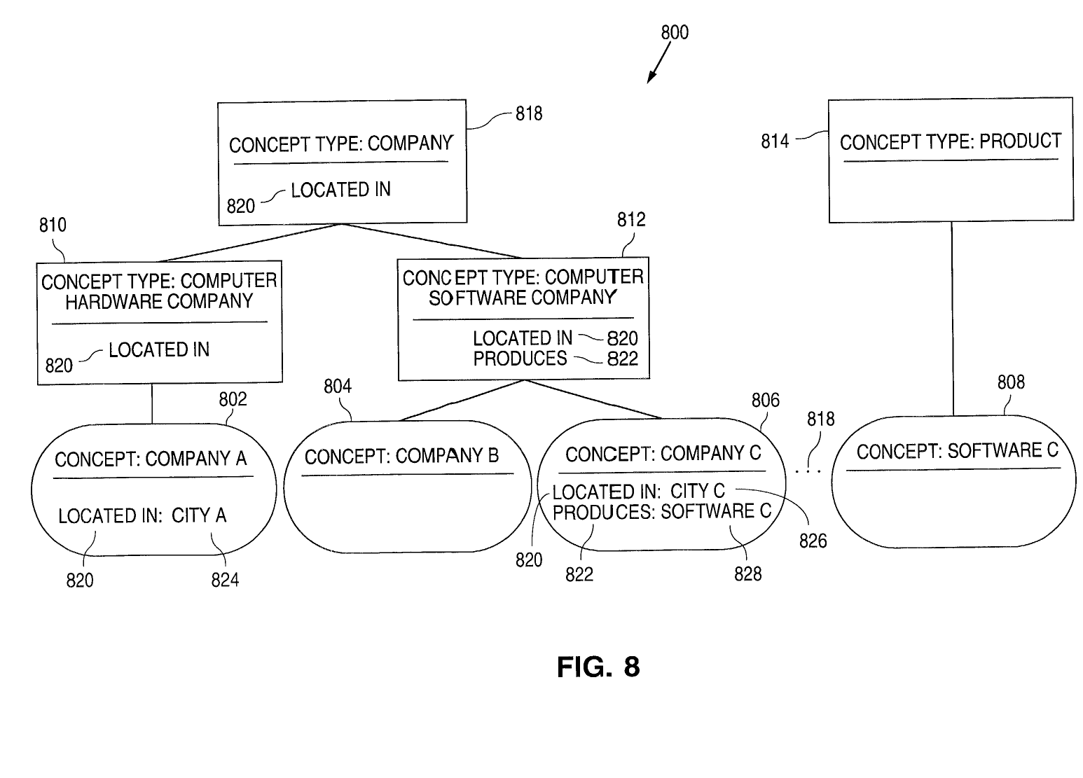

In an embodiment of the invention, the concept association dictionary 708 includes a conceptual taxonomy. The conceptual taxonomy defines relationships between two or more concepts. FIG. 8 illustrates an example of a conceptual taxonomy. The conceptual taxonomy 800 includes concepts “Company A” 802, “Company B” 804, “Company C” 806, and “Software C” 808. These four concepts are concepts that may be recognized in a document and may each be defined by a set of features in the concept dictionary 404. As shown in FIG. 8, the conceptual taxonomy 800 also includes concept types “Company” 818, “Computer Hardware Company” 810, “Computer Software Company” 812, and “Product” 814. A concept type groups one or more concepts that represent similar ideas. As shown in FIG. 8, Concepts “Company A” 802, “Company B” 804, and “Company C” 806 belong to the concept type “Company” 818. Here, the three concepts grouped under the concept type “Company” 818 are each examples of a company. In this example, Companies B and C are computer software companies, and the concepts “Company B” 804 and “Company C” 806 are additionally grouped under the concept type “Computer Software Company” 812 under the concept type “Company” 818. Company A in this example is a computer hardware company, and concept “Company A” 802 is grouped under the concept type “Computer Hardware Company” 810 under the concept type “Company” 818. Concept “Software C” 808 is grouped under the concept type “Product” 814. It should be recognized that the conceptual taxonomy 800 is a simplified example of a conceptual taxonomy and additional concepts and/or concept types may be included.

In an embodiment of the invention, a concept type defines zero or more concept properties. A child concept type (for example, concept type “Computer Software Company” 812) inherits all properties of a parent concept type (for example, concept type “Company” 818) and may additionally define zero or more concept properties. For example, the parent concept type “Company” 818 may define a concept property “Located in” 820. Child concept types “Computer Software Company” 812 and “Computer Hardware Company” 810 each inherit the concept property “Located in” 820 and may each additionally define zero or more concept properties. For instance, the concept type “Computer Software Company” 812 defines the concept property “Located in” 820 (inherited) and may additionally define a concept property “Produces” 822. Concept type “Computer Hardware Company” 810 may simply define the concept property “Located in” 820 (inherited).

A concept grouped under a concept type may be assigned a concept property value for each concept property defined by the concept type. If a concept is grouped under a child concept type that is under a parent concept type, the concept may be assigned a concept property value for each concept property inherited from the parent concept type and for each additional concept property defined by the child concept type. With reference to FIG. 8, concept “Company A” 802 may be assigned a concept property value “City A” 824 for the concept property “Located in” 820. Also, concept “Company C” 806 may be assigned concept property values “City C” 826 and “Software C” 828 for the concept properties “Located in” 820 and “Produces” 822, respectively. It should be recognized that assigning “Software C” as a concept property value for concept “Company C” 806 creates a relationship or concept association between two concepts that are not grouped under a common concept type. FIG. 8 illustrates this concept association by a dashed line 818.

The conceptual taxonomy 800 enables a conceptual search that specifies one or more concept types and/or one or more concept properties and/or one or more associated concept property values. For instance, rather than merely identifying documents that express one or more concepts of interest, the conceptual taxonomy 800 enables a search engine 130 to identify one or more documents by specifying one or more concept types of interest.

In an embodiment of the invention, the document modeling module 122 references the concept association dictionary 708 in generating a document's conceptual model. The document modeling module 122 may incorporate one or more recognized concepts and also one or more concept associations for the recognized concepts in a conceptual model. For example, a conceptual model may indicate a concept type or types of a recognized concept. With reference to FIG. 8, a conceptual model for a document expressing the concept “Company C” 806 may indicate the concept “Company C” 806 and the concept type “Company” 818 and/or concept type “Computer Software Company” 812. Alternatively, or in addition, the document modeling module 122 may incorporate a concept property and/or an associated concept property value for a recognized concept in a conceptual model. With reference to FIG. 8, a conceptual model for a document expressing the concept “Company C” 806 may indicate the concept “Company C” 806 and the concept property “Located in” 820 and/or the associated concept property value “City C” 826. In addition, the conceptual model may indicate the concept property “Produces” 822 and/or the associated concept property value “Software C” 828.

The document modeling module 122 may incorporate one or more concept types in a conceptual model by including one or more concept type identifications of the one or more concept types. A concept type identification, which may be any alphanumeric and/or symbolic string, uniquely identifies a concept type. It should be recognized that a concept type identification of a given concept type need not include a literal expression of the concept type. For example, a concept type identification “1+” may be used to uniquely identify the concept type “Computer Software Company” 812, and “1+” may be included in a conceptual model in place of “Computer Software Company”. In this example, a mapping between the concept type identification “1+” and the concept type “Computer Software Company” may be included in a concept map 402. In an embodiment of the invention, a document modeling module 122 assigns a concept type identification to a recognized concept of a given concept type and generates a conceptual model based upon the concept type identification. Similarly, a concept property identification and/or an associated concept property value identification, each of which may be any alphanumeric and/or symbolic string, may be included in a conceptual model.

In an alternate embodiment, a search engine 130 may be configured to perform a conceptual search that references a conceptual taxonomy 800 when performing the search. The search engine 130 may reference the concept association dictionary 708 via a transmission channel 106 or may reference an imported file including at least a portion of the conceptual taxonomy 800.

Thus, with reference to FIG. 8, a conceptual search may query for documents that express any of the concepts under the concept type “Computer Software Company” 812, for example. In this case, the search may identify one or more documents that express either or both concepts “Company B” 804 and “Company C” 806. As another example, the conceptual search may identify documents by concept type “Company” 818 and having concept property value “City A” 824 associated with concept property “Located in” 820. Here, the conceptual search may identify one or more documents that express the concept “Company A” 802.

In an embodiment of the invention, the concept association dictionary 708 includes a plurality of conceptual taxonomies. In an alternate embodiment of the invention, two or more conceptual taxonomies include the same set of concept types and the same set of concepts. However, each conceptual taxonomy may have a different grouping of concept types and/or concepts. Multiple conceptual taxonomies promote flexibility by tailoring a single concept map 402 for different applications involving different points of view. For example, a first conceptual taxonomy may be the conceptual taxonomy 800 illustrated in FIG. 8. A second conceptual taxonomy may include the same set of concept types and the same set of concepts as illustrated in FIG. 8. However, the second conceptual taxonomy may group the concept “Company B” 804 under concept type “Computer Hardware Company” 810 along with concept “Company A” 802. In this example, Company B may produce both computer software products and computer hardware products. Depending upon a user's point of view, Company B may be deemed a computer software company or a computer hardware company. The first and second conceptual taxonomies are tailored to these differing points of view and may enable a conceptual search to locate documents in accordance with a user's point of view. It should be recognized that each conceptual taxonomy may have a corresponding set of concept properties and concept property values.

In an embodiment of the invention with multiple conceptual taxonomies, the document modeling module 122 may generate a conceptual model in accordance with each conceptual taxonomy. While the conceptual models may indicate the same recognized concept or concepts, the conceptual models may indicate one or more different concept associations for the one or more recognized concepts. Alternatively, the document modeling module 122 may generate a conceptual model in accordance with one or more conceptual taxonomies specified by a user, such as a user of the computer 128 in FIG. 1.

In another embodiment of the invention having multiple conceptual taxonomies, the document modeling module 122 generates a conceptual model that is generic for all conceptual taxonomies. For example, the generated conceptual model may indicate recognized concepts and/or corresponding concept weights but may not indicate concept associations for the recognized concepts. A search engine 130 may be configured to perform a conceptual search that references one or more conceptual taxonomies of interest during the search. As discussed previously, the search engine 130 may reference the concept association dictionary 708 via a transmission channel 106 or may reference an imported file including at least a portion of the one or more conceptual taxonomies of interest.

In addition to generating a conceptual model 600 for a document, the document modeling module 122 may additionally assign one or more auto-attributes and/or one or more auto-categories to the document.

An auto-attribute is generated or assigned to a document based on the document's conceptual model and/or one or more original attributes. As discussed previously, one or more original attributes may be extracted from a document and/or a document source 104. In an embodiment of the invention, a document integration module 120 includes the one or more original attributes in an XML document and brackets the one or more original attributes by tag pairs.

In an embodiment of the invention, an auto-attribute is a predetermined descriptive label that is assigned to a document that meets a certain criterion. An example of an auto-attribute that may be assigned to a document include document type, such as “Useful Document”, “Marketing Brochure Document”, or “FAQ Document”. An auto-attribute may also indicate a document subject, such as, for example, “Automobiles”. An auto-attribute that may be assigned to a document has a corresponding auto-attributing rule. The document modeling module 122 includes one or more auto-attributing rules in an auto-attributing dictionary 712 as shown in FIG. 7. In operation, the document modeling module 122 determines whether a document satisfies an auto-attributing rule. If the auto-attributing rule is satisfied, the document modeling module 122 may assign the corresponding auto-attribute to the document.

In an embodiment of the invention, an auto-attributing rule may specify a criterion based on one or more elements of the following types: concept, concept weight, concept type, concept property, concept property value, and original attribute. Hence, in generating or assigning an auto-attribute to a document, the document modeling module 122 may reference or examine one or more of the following sources: the document's conceptual model 600, the concept association dictionary 708, and the document in the XML format (or other format). The auto-attributing rule may specify a criterion that involves one or more elements in conjunction with one or more logical and/or mathematical relations. Examples of logical and mathematical relations include “and”, “or”, “not”, “greater”, “greater than or equal”, “less than”, “less than or equal”, “equal”, “not equal”, and “like”. In addition, a grouping relation, symbolically represented as “( )”, may be used. It should be recognized that these relations are used herein to represent pseudo code relations and need not correspond to relations in any particular computer language.

As an example, an auto-attributing rule may specify that documents expressing a concept “web browser” or a concept “network application” or a concept “internet” should be assigned an auto-attribute “Technology”. As another example, an auto-attributing rule may specify that documents expressing a concept grouped under a concept type “Computer Software” and having a Creation Date original attribute greater than “Jan. 12, 2000” should be assigned an auto-attribute “Useful Document”. An auto-attributing rule may also specify a criterion based on how closely a document's conceptual model matches an example document's conceptual model. It should be recognized that such criterion is similar to a conceptual QBE search discussed previously.

By employing auto-attributing rules, the invention permits precise and consistent assignment of labels to documents. This precise and consistent assignment in turn allows efficient and proper identification and retrieval of documents by or for a user.

The invention may assign labels to documents without any review of the documents by a human viewer. Moreover, an auto-attributing rule may be user-defined and may be tailored to a user's needs. For instance, an auto-attributing rule may specify that a document expressing a concept “Internet” and having a Creation Date original attribute greater than “Jan. 1, 2001” should be assigned an auto-attribute “Useful Document”. Alternatively, the auto-attributing rule may be modified to specify that a document expressing a concept “Municipal Bond” and having a Creation Date original attribute greater than “Jan. 1, 2001” should be assigned the auto-attribute “Useful Document”.

In an embodiment of the invention, a document is assigned an auto-attribute for each auto-attribute rule that the document satisfies. Hence, a document may be assigned more than one auto-attribute. In another embodiment, a document modeling module 122 sequentially determines whether a document satisfies a plurality of auto-attribute rules and assigns an auto-attribute corresponding to a first auto-attribute rule that the document satisfies. Other embodiments attempt to locate a most suitable rule or rules that a document may satisfy and assign an attribute or attributes corresponding to the rule or rules.

In an embodiment of the invention, the document modeling module 122 may assign a document to one or more categories in a categorization taxonomy. A document may be assigned to a category if the document meets a certain criterion. FIG. 9 illustrates an example of a categorization taxonomy. In this example, the categorization taxonomy 900 includes a plurality of categories, which represent various document subjects. The categorization taxonomy 900 includes categories “Politics” 902, “Sports” 904, and “Computers” 906, which are the main categories in this example. The categorization taxonomy 900 also includes categories “U.S. Politics” 914 and “Foreign Politics” 916 under the category “Politics” 902. Categories “Basketball” 908, “Football” 910, and “Baseball” 912 are included under the category “Sports” 904. It should be recognized that a document assigned to the category “U.S. Politics” 914, for example, is also assigned to the category “Politics” 902.

In an embodiment of the invention, one or more categories of a categorization taxonomy have a corresponding auto-categorization rule. With reference to FIG. 7, the document modeling module 122 includes one or more auto-categorization rules in an auto-categorization dictionary 714. The document modeling module 122 determines whether a document satisfies an auto-categorization rule. If the auto-categorization rule is satisfied, the document modeling module 122 assigns the document to the corresponding category. In an embodiment of the invention, not all categories in a categorization taxonomy may have a corresponding auto-categorization rule. For example, a category that is a main category, such as “Politics” 902 in FIG. 9, may not have a corresponding auto-categorization rule if categories which are sub-categories, such “U.S. Politics” 914 and “Foreign Politics” 916, have corresponding auto-categorization rules.

In an embodiment of the invention, a document assigned to a category may be assigned an auto-category that indicates the category. For example, a document assigned to the category “U.S. Politics” 914 may be assigned an auto-category “U.S. Politics”. It should be recognized that an auto-category may be any label that uniquely identifies a category, such as, for example, any alphanumeric and/or symbolic string.

In an embodiment of the invention, an auto-categorization rule may specify a criterion based on one or more elements of the following types: concept, concept weight, concept type, concept property, concept property value, original attribute, and auto-attribute. Hence, in generating or assigning an auto-category to a document, the document modeling module 122 may reference or examine one or more of the following sources: the document's conceptual model 600, the concept association dictionary 708, the document in the XML format (or other format), and one or more auto-attributes assigned to the document. As with an auto-attributing rule, an auto-categorization rule may specify a criterion that involves one or more elements in conjunction with one or more logical and/or mathematical relations and/or grouping relations. An auto-categorization rule may also specify a criterion based on how closely a document's conceptual model matches an example document's conceptual model.

As an example, an auto-categorization rule may specify that documents expressing a concept “web browser” or a concept “network application” or a concept “internet” may be assigned to the category “Computers” 906 in FIG. 9.

By employing auto-categorization rules, the invention permits precise and consistent categorization of documents to one or more categories of a categorization taxonomy. This precise and consistent categorization in turn allows efficient and proper identification and retrieval of documents by or for a user.

The invention may categorize documents without any review of the documents by a human viewer. It should be recognized that an auto-categorization rule may be user-defined and may be tailored to a user's needs.

With reference to FIG. 1, the memory 118 includes the modeling directory 124. The modeling directory 124 may be any data repository, such as, for example, a relational database. In one embodiment of the invention, the document modeling module 122 stores at least a portion of the generated metadata for the document 108 in the modeling directory 124. In particular, the document modeling module 122 may store at least a portion of the generated conceptual model 600. Alternatively or in conjunction, the document modeling module 122 may store one or more auto-attributes assigned to the document 108 and/or one or more auto-categories assigned to the document 108.

In an embodiment of the invention, the document modeling module 122 associates at least the stored metadata with the document 108, such as by providing a link or identifier that identifies the document 108 and/or provides a location of the document 108 in the document source 104. This link or identifier may be stored in conjunction with the stored metadata. The search engine 130 may access the modeling directory 124 via the transmission channel 106 and identify the document 108 if its stored metadata matches a search query. If the document 108 is identified, a user, such as a user of the computer 128, may retrieve the document 108 from the document source 104.

Alternatively, and/or in conjunction with the above, the server computer 102 may transmit at least a portion of the generated metadata to the document source 104. In an embodiment of the invention, the document modeling module 122 associates at least a portion of the generated metadata with the document 108, such as by providing a link or identifier that identifies the document 108 and/or provides the location of the document 108 in the document source 104. The document modeling module 122 submits the metadata (along with the link or identifier) to the document integration module 120. The document integration module 120 transmits the metadata (along with the link or identifier) via transmission channel 106 to the document source 104. The document source 104 may store the transmitted metadata in the memory 136. The search engine 130 may access the transmitted metadata that is stored in the memory 136 and may identify the document 108 if its stored metadata matches a search query. It should be recognized that the document integration module 120 in an alternate embodiment of the invention may provide the link or identifier.

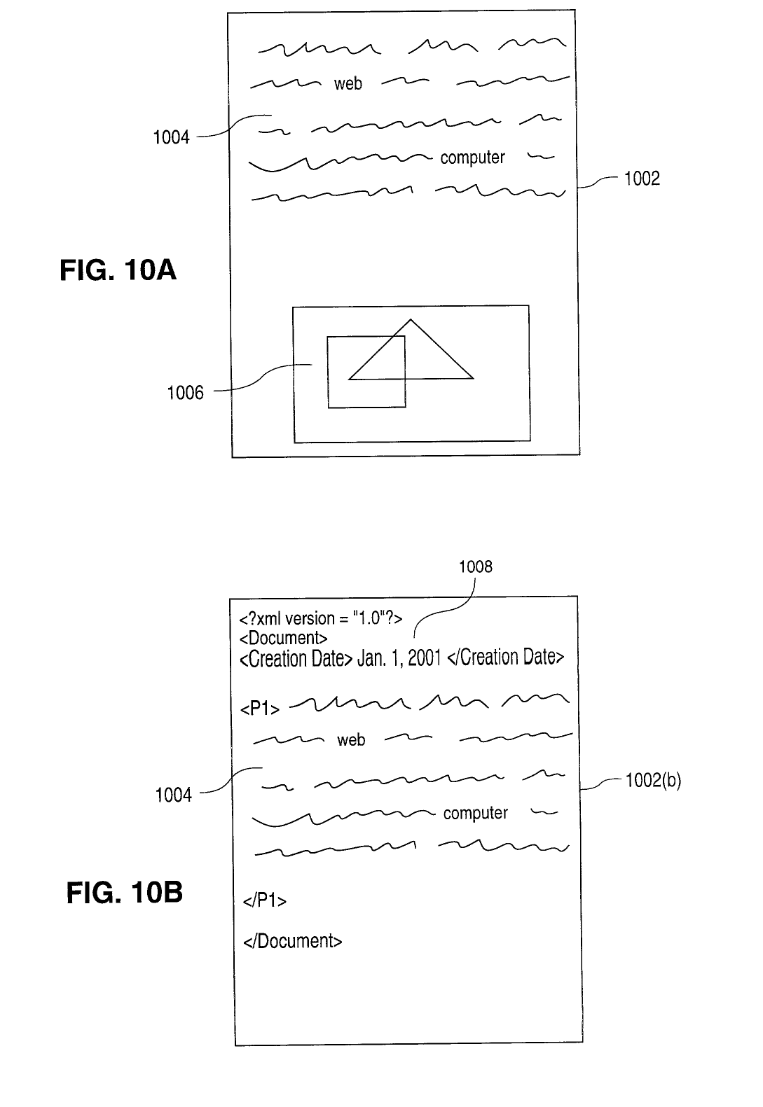

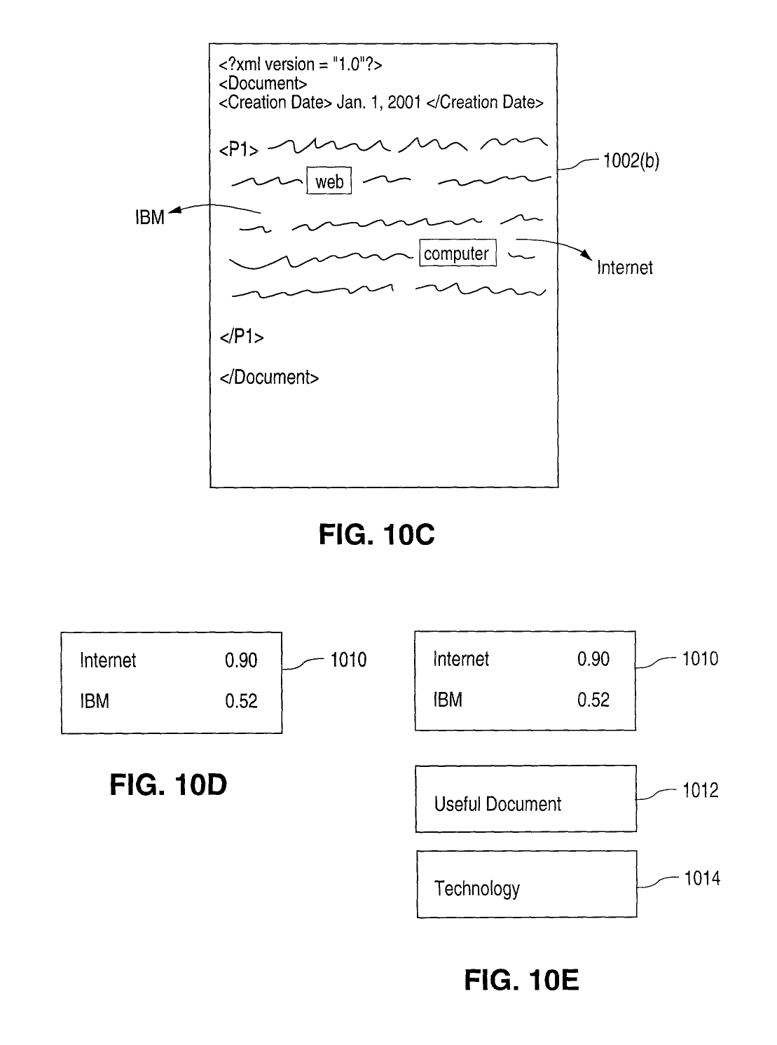

FIGS. 10A-E illustrate a sequence of processing steps that may be performed on a document in accordance with an embodiment of the invention. FIG. 10A shows a document 1002, which in this example is a Word document. The document 1002 is initially stored in a document source 104, and a copy of the document 1002 is received by a document integration module 120. As shown in FIG. 10A, the document 1002 has a text portion 1004 and a non-text portion 1006. The non-text portion 1006 in this example is a still image (e.g., a JPEG image).

The document integration module 120 coverts the copy of the document 1002 in the Word format to a XML document 1002(b) as shown in FIG. 10B. In this example, the document integration module 120 has extracted an original attribute “Jan. 1, 2001” 1008 of the document 1002 from the document source 104 and has included the original attribute in the XML document 1002(b). As shown in FIG. 10B, “Jan. 1, 2001” is shown bracketed by a tag pair <Creation Date> and </Creation Date>. The non-text portion 1006 has been separated, and the text portion 1004 is shown bracketed by a tag pair <P1> and </P1>.

A document modeling module 122 processes the XML document 1002(b). In particular, the document modeling module 122 recognizes a concept “Internet”. In this example, the concept “Internet” may be defined by a set of features comprising “network”, “web”, “TCP/IP”, “computer”, and “Internet”. As shown in FIG. 10C, the document modeling module 122 determines that two features (“web” and “computer”) are present in the XML document 1002(b). Using the feature weights associated with these two features (for example, 0.9 and 0.05, respectively), the document modeling module 122 calculates a concept weight for the concept “Internet”, such as, for example, by adding the feature weights. In this example, the calculated concept weight of 0.95 exceeds a threshold value of 0.1, and the concept “Internet” is determined to be recognized. As shown in FIG. 10C, the document modeling module 122 also recognizes a second concept “IBM”. It should be recognized that the concept “IBM” may be defined by another set of features, which may include one or more features defining the concept “Internet”.

The document modeling module 122 generates a conceptual model 1010 for the document 1002 based on the recognized concepts “Internet” and “IBM”. As shown in FIG. 10D, the document modeling module 122 incorporates the recognized concepts “Internet” and “IBM” and their calculated concept weights in the conceptual model 1010.

As shown in FIG. 10E, the document modeling module 122 assigns an auto-attribute “Useful Document” 1012 to the document 1002. In this example, an auto-attributing rule for the auto-attribute “Useful Document” 1012 specifies that documents expressing the concept “Internet” and having the Creation Date original attribute greater than “Jan. 1, 2000” should be assigned the auto-attribute “Useful Document” 1012. The document modeling module 122 references the conceptual model 1010 and determines that the concept “Internet” is indicated. The document modeling module 122 references the document in the XML format 1002(b) and determines that the Creation Date original attribute is greater than “Jan. 1, 2000”.

The document modeling module 122 also assigns an auto-category “Technology” 1014 to the document 1002. In this example, an auto-categorizing rule may specify that documents expressing the concept “Internet” or the concept “IBM” should be assigned the auto-category “Technology” 1014.

In this example, the document modeling module stores the generated metadata 1010, 1012, 1014 in a modeling directory 124 along with a link or identifier (not shown in FIG. 10E). A search engine 130 may access the modeling directory 124, for example, via transmission channel 106, to identify the document 1002 if the stored metadata 1010, 1012, 1014 matches a search query. If document 1002 is identified, a user may retrieve the document 1002 from the document source 104.

The foregoing descriptions of specific embodiments of the present invention are presented for purposes of illustration and description. They are not intended to be exhaustive or to limit the invention to the precise forms disclosed. Obviously many modifications and variations are possible in view of the above teachings.

For instance, with reference to FIG. 1, a document to be processed by the invention may be initially stored in the memory 118 of the server computer 102 and need not be retrieved or submitted from the document source 104. In this variation, the search engine 130 may identify the document stored the server computer 102 via the transmission channel 106.

With reference to FIG. 1, instead of receiving the document 108 (or a copy thereof), the document integration module 120 may receive a portion of the document 108, such as the text-portion 110, and/or one or more original attributes of the document 108.

With reference to FIG. 1, in addition to storing generated metadata, the memory 118 may store the document 108 (or a copy thereof) in either its initial format as received from the document source 104 or in its common format. In an embodiment of the invention, the document 108 is received from the document source 104 and is stored in the memory 118, and a copy of the document 108 is generated and submitted for processing by the document modeling module 122. Alternatively or in conjunction with the above, the memory 118 may store a portion of the document 108, such as the text portion 110 or the non-text portion 112. Alternatively or in conjunction with either of the above, the memory 118 may store one or more original attributes extracted from the document 108 (or from a copy thereof) and/or from the document source 104.

With reference to FIG. 1, the document integration module 120, the document modeling module 122, and the modeling directory 124 may reside in two or more separate server computers connected by transmission channel(s), which may be any wire or wireless transmission channel.

With reference to FIG. 1, an embodiment of the invention may include the document modeling module 122 but not the document integration module 120 in the memory 118. In this embodiment, a document to be processed by the invention may be initially stored in the memory 118 of the server computer 102 and need not be retrieved or submitted from the document source 104.

An embodiment of the invention may assign or generate an auto-attribute to a document based on one or more auto-categories of the document.

Instead of assigning one or more auto-categories to a document, an embodiment of the invention may categorize the document by storing the document in one or more individual databases. Each individual database may correspond to a category, and the individual databases may reside in the memory 118 shown in FIG. 1.

An embodiment of the invention may associate at least a portion of the generated metadata of a document to the document by affixing (or otherwise incorporating) the portion of the generated metadata to the document itself.

An embodiment of the invention may include a help system, including a wizard that provides assistance to users, as well as technical staff responsible for configuring a computer network (e.g., the computer network 100) and its various components.

An embodiment of the present invention further relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher level code that are executed by a computer using an interpreter. For example, an embodiment of the invention may be implemented using Java, C++, or other object-oriented programming language and development tools.

Finally, it should be recognized that the invention may be embodied in hardwired circuitry in place of, or in combination with, machine-executable software instructions.

An ordinary artisan should require no additional explanation in developing the methods and systems described herein but may nevertheless find some helpful guidance in the preparation of these methods and systems by examining standard reference works in the relevant art. For example, an ordinary artisan may choose to review related patents, such as U.S. Pat. No. 6,028,605, entitled “Multi-Dimensional Analysis of Objects by Manipulating Discovered Semantic Properties,” which issued on Feb. 22, 2000 in the names of Tom Conrad and Scott Wiener, the disclosure of which is incorporated herein by this reference.

A skilled artisan might also find some helpful guidance by reviewing the provisional application Ser. No. 60/192,236 entitled “Method and Apparatus for Identifying Document Contents for Rapid Retrieval,” which was filed on Mar. 27, 2000 in the names of Victor Spivak, Alex Rankov, Howard Shao, Razmik Abnous, and Matt Shananhan, the disclosure of which is incorporated herein by this reference.

It should be recognized that the embodiments were chosen and described in order to explain the principles of the invention and its applications, to thereby enable others skilled in the art to utilize the invention and various embodiments with various modifications as are suited to various uses. It is intended that the scope of the invention be defined by the following claims and their equivalents.

We claim:

1. A computer-implemented method of processing a document, said method comprising:
converting a document into a common format document;
recognizing a concept in said common format document, wherein said concept represents a basic idea expressed in said common format document; and
incorporating said concept in a conceptual model.

2. The computer-implemented method of claim 1, wherein recognizing said concept includes:
identifying a plurality of features in said common format document, wherein said plurality of features represents evidence of said concept in said common format document.

3. The computer-implemented method of claim 2, wherein recognizing said concept further includes:
calculating a concept weight for said concept using a plurality of feature weights associated with said plurality of features, wherein said concept weight represents a recognition confidence level for said concept; and
comparing said concept weight with a predetermined threshold value.

4. The computer-implemented method of claim 1, further comprising:
by referencing said conceptual model, generating an auto-attribute, said auto-attribute being a descriptive label for said common format document.

5. The computer-implemented method of claim 1, further comprising:
by referencing said conceptual model, assigning said common format document to a subject category.

6. The computer-implemented method of claim 1, wherein said converting includes converting said document into a common format document that is in an XML format.

7. A computer-readable medium to direct a computer to function in a specified manner, comprising:
instructions to recognize a basic idea expressed in a document;
instructions to assign a concept identification to said basic idea; and
instructions to generate a conceptual model based upon said concept identification.

8. The computer-readable medium of claim 7, wherein said instructions to recognize said basic idea include:
instructions to determine whether a plurality of features is present in said document, wherein said plurality of features represents evidence that said basic idea is expressed in said document.

9. The computer-readable medium of claim 8, wherein said instructions to recognize said basic idea further include:
instructions to calculate a recognition confidence level for said basic idea using a plurality of feature weights associated with said plurality of features; and
instructions to compare said recognition confidence level with a predetermined threshold value.

10. The computer-readable medium of claim 9, wherein said instructions to generate said conceptual model include:
instructions to incorporate said recognition confidence level in said conceptual model.

11. The computer-readable medium of claim 7, further comprising:
instructions to assign an auto-attribute to said document based upon said conceptual model, wherein said auto-attribute represents a descriptive label for said document.

12. The computer-readable medium of claim 7, further comprising:
instructions to place said document in a category of a categorization taxonomy based upon said conceptual model, wherein said categorization taxonomy includes a plurality of categories.

13. The computer-readable medium of claim 12, wherein said instructions to place said document in said category include:
instructions to assign an auto-category to said document, wherein said auto-category represents a descriptive label for said category.

14. A computer, comprising:
a processor; and
a memory connected to said processor, wherein said memory includes:
a document modeling module, said document modeling module having:
a first module configured to direct said processor to recognize a concept in a document, wherein said concept represents a basic idea expressed in said document; and
a second module configured to direct said processor to generate a conceptual model based upon said concept.

15. The computer of claim 14, wherein said memory further includes:
a document integration module, said document integration module having:
a third module configured to direct said processor to convert an initial format document to said document, which has a common format.

16. The computer of claim 15, wherein said document integration module further has:
a fourth module configured to direct said processor to separate a text portion from said initial format document; and
a fifth module configured to direct said processor to incorporate said text portion in said document.

17. The computer of claim 14, wherein said first module has:
a sixth module configured to direct said processor to determine whether a plurality of features is present in said document, wherein said plurality of features represents evidence of said concept in said document;
a seventh module configured to direct said processor to calculate a concept weight for said concept using a plurality of feature weights associated with said plurality of features, wherein said concept weight represents a recognition confidence level for said concept; and
an eighth module configured to direct said processor to compare said concept weight with a predetermined threshold value.

18. The computer of claim 14, wherein said memory further includes:
a modeling directory,
and wherein said document modeling module further has:
a ninth module configured to direct said processor to store said conceptual model in said modeling directory.

19. The computer of claim 14, wherein said document modeling module further has:
a tenth module configured to direct said processor to generate an auto-attribute based upon said conceptual model, wherein said auto-attribute represents a descriptive label for said document.

20. The computer of claim 14, wherein said document modeling module further has:
an eleventh module configured to direct said processor to categorize said document in a category of a plurality of categories based upon said conceptual model.
